(19) United States
(12) Patent Application Publication
(10) Pub. No.: US 2010/0145854 A1
(43) Pub. Date: Jun. 10, 2010

(54) SYSTEM AND METHOD TO ENABLE A SECURE ENVIRONMENT FOR TRUSTED AND UNTRUSTED PROCESSES TO SHARE THE SAME HARDWARE

(75) Inventors: Tom Messerges, Schaumburg, IL (US); Tom Mihm, Crystal Lake, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Holtsville, NY (US)

(21) Appl. No.: 12/330,293

(22) Filed: Dec. 8, 2008

(51) Int. Cl. H04L 9/32; G06Q 40/00; G06Q 20/00

(52) U.S. Cl. 705/44; 705/35

(57) ABSTRACT

The invention relates to systems and or methodologies for enabling a secure environment for trusted and untrusted processes to share the same hardware. A separation component segregates, isolates, or otherwise separates trusted and untrusted processes and/or scripts to ensure that payment card industry and PIN entry device security standards are maintained.

### BACKGROUND

Mobile communication and computing technologies have experienced significant growth over the past several years. This growth has lead to mobile computing systems of increased sophistication and complexity. Additionally, payment card technology has proliferated throughout the marketplace. However, the advancements of security features in mobile devices, has not kept pace with the advancement of security requirements for payment card transactions.

The ease and security with which payment cards can now be used has led to increased benefit for consumers and retailers. Furthermore, mobile devices can now complete tasks that were the sole domain of much larger and more expensive computers just a few years ago. However, implementing the security features necessary to process payment card transactions on a mobile device can result in increased size and/or complexity of the device.

Currently, in order to satisfy the necessary security requirements many retailers use separate devices for mobile communication/computing and processing payment card transactions. In addition, some mobile devices have peripheral devices that are used to process payment cards. However, both of the aforementioned solutions can be costly and inefficient. Therefore, it would be desirable to have a system and/or methodology of providing a secure environment for trusted processes, such as payment card transactions on a multi-purpose device.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

The subject disclosure provides for a secure environment for trusted and untrusted processes to share the same hardware. In some aspects, disclosed is a system facilitating secure processes, that includes a general-purpose component that executes unsecure processes, a payment component that executes secure processes, and a separation component that separates the general-purpose component and the payment component, and enables switching between the general-purpose component and the payment component.

In other aspects disclosed is a method for facilitating a secure environment for trusted processes on a device, that includes separating a general mode and a payment mode, and executing untrusted processes in the general mode and trusted processes in the payment mode, enabling secure switching between the general mode and payment mode, wherein the switching separates the trusted and untrusted processes, and auditing the switches between at least one of the general mode, or the payment mode.

According to still other aspects, provided is a system for trusted processing. The system includes means for separating an untrusted mode and a trusted mode, and executing untrusted processes in the untrusted mode and trusted processes in the trusted mode, means for enabling secure switching between the untrusted mode and trusted mode, wherein the switching separates the trusted and untrusted processes, auditing the switches between the modes via at least one of: maintaining a record of each switch, reporting switches, or requiring a security clearance in order to switch, and printing a receipt only if authorized by at least one secure process.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates an example mobile computer and payment system in accordance with an aspect the subject specification.

FIG. 2 illustrates an example hierarchy of trust in accordance with an embodiment of the subject specification.

FIG. 3 illustrates a dual-purpose mobile computer and payment device in accordance with an aspect of the subject specification.

FIG. 4 illustrates an example general component block diagram schematic of a mobile device including a secure payment solution in accordance with an aspect of the subject specification.

FIG. 5 illustrates an example block diagram of a mobile device with an integrated secure payment solution in accordance with an aspect of the subject specification.

FIG. 6 illustrates an example methodology for enabling a secure environment for trusted and untrusted processes to share the same hardware in accordance with an aspect of the subject specification.

FIG. 7 illustrates a system that employs an artificial intelligence component that facilitates automating one or more features in accordance with the subject specification.

FIG. 8 illustrates an example of a handheld terminal operative to execute one or more of the systems and/or methods in accordance with the subject specification.

FIG. 9 illustrates an exemplary device operative to execute the one or more embodiments disclosed herein.

### DETAILED DESCRIPTION

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used.

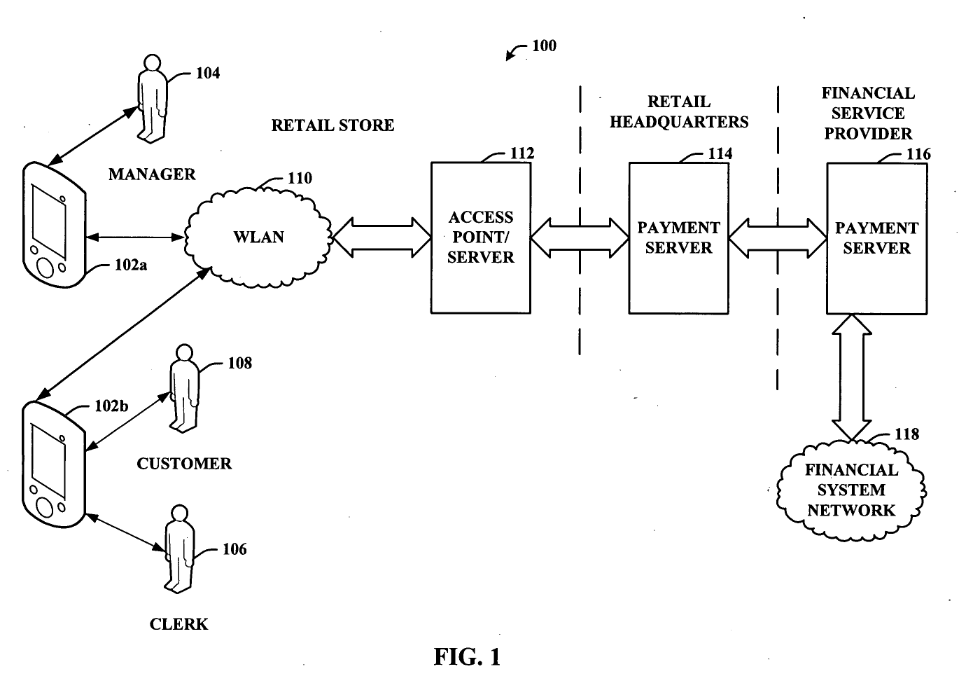

FIG. 1 illustrates an example mobile computing and payment system in accordance with an aspect of the subject specification. The system 100 can include a plurality of mobile devices 102 (e.g. 102a-b). The mobile devices 102 can include devices such as cell phones, smart phones, laptops, handheld communication devices, handheld computing devices, satellite radios, global positioning systems, PDAs, and so forth. In this example, the mobile devices 102 can function as dual-purpose mobile computers and payment processing devices (discussed infra). For example, a manager 104 and/or a clerk 106 can use the mobile devices 102 for inventory control, communication (intra-store, global, etc.), general-purpose applications (e.g., email, etc.), customer assistance applications (e.g. price check, etc.), employee management, and so forth.

Additionally or alternatively, the mobile devices 102 can be used to process credit card payments. For instance, a customer 108 can request the clerk 106 lookup the price for one or more items, and the clerk can check the prices via the mobile device 102b. The clerk 106 can also process one or more credit card payments for the item via the mobile device 102b, wherein the customer swipes or scans their card and can enter a Personal Identification Number (PIN) using the mobile device 102b. The mobile device 102b collects the customer's 108 payment data, and processes the payment.

The mobile devices 102 can communicate with a wireless local area network (WLAN) 110. The WLAN 110 is accessible via an access point 112, wherein the access point 112 is a WLAN server. For example, the access point 112 can be a WLAN server in a retail store, and the mobile device 102 can communicate the customer's 108 payment data to the access point 112. In addition, the access point is in communication with a global communication framework (e.g., the Internet or a leased line). Continuing with the previous example, the mobile device 102 can communicate the customer's 108 payment data to the access point 112 via the WLAN 110. The access point 112 (e.g., server) can communicate the payment data to a payment server 114 via the global communication framework. For example, the payment server 114 can be located in a retail headquarters and receive payment data from a plurality of retail stores via the global communication framework. The payment server 114 facilitates the processing of credit card transactions, and can take most any steps necessary or required to submit the data to a payment server 116 maintained by a financial service provider. The payment server 116 is a gateway into the financial service provider's financial system network 118. The financial system network 118 processes the payment data, debits the customer's account, and so forth. Additionally, the financial system network 118 informs the retailer's payment server 114 that the payment was successfully processed. The payment server 114 can communicate the outcome of the payment processing to the access point 112 via the global communication framework, and the mobile device 102b can obtain the information via the WLAN 110.

The access point 112, payment servers 114 and 116, and financial system network 118 collectively comprise a backend system, wherein the clerk 108 and the customer 106 have only limited access (e.g., via the mobile device 102b) to the backend system. A receipt can be produced (e.g., printed, electronically distributed, etc.) as a means of confirming that a payment card transaction was successfully processed (e.g., accepted or declined) by the backend system. It is to be appreciated that this is but one example of a mobile computing and payment system, and a plurality of configurations are possible with the scope and spirit of the subject innovation.

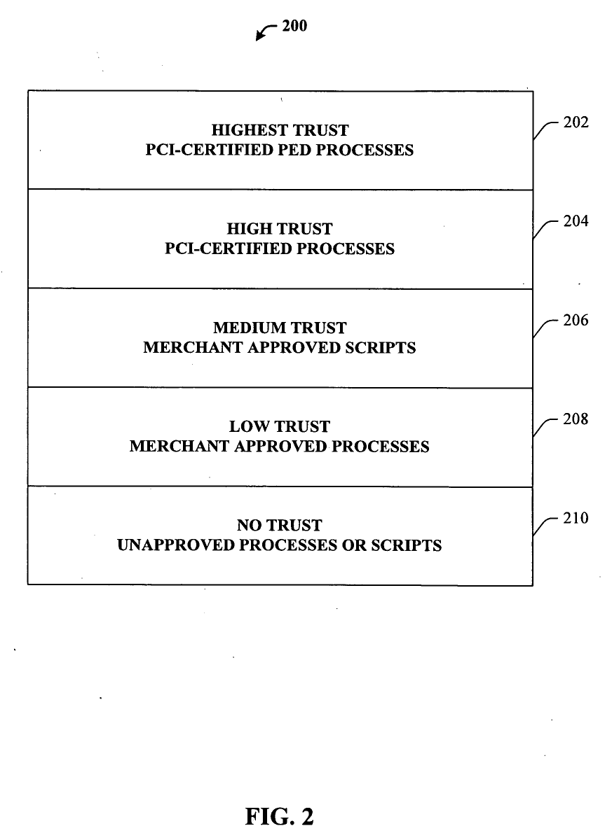

FIG. 2 illustrates an example hierarchy of trust in accordance with an embodiment of the subject innovation. The hierarchy 200 is illustrative of the levels of trust a payment service provider (e.g., an acquiring bank) places on a merchant's mobile device to execute various processes and/or scripts related to communication and/or payment processing. The first level or highest trust 202 is for processes adhering to the Payment Card Industry's (PCI) level for achieving Pin Entry Device (PED) certification (e.g., PCI-certified PED processes, PCI-PED processes). At 202, the PCI-certified PED processes are trusted to handle plaintext (e.g., not encrypted) PIN data. This level of trust requires PED certification by a PCI-approved laboratory. The PED certification process can be costly and time consuming, and consequently it may be desirable to keep recertification to a minimum if at all. For example, if there were a change in one or more PCI-certified PED processes, then the device would have to be recertified to ensure that it can still be trusted to handle plaintext PIN data.

The second level or high trust level 204 is for PCI-certified processes that do not involve PIN entry. The PCI-certified processes at 204 are trusted to handle sensitive customer payment data, not including plaintext PIN data. For example, an operating system may include a payment application that handles magnetic stripe or near-field communication (NFC) data. Processes hosted on the second level 204 must also be certified PCI compliant, but this certification process can be less rigorous than a PED certification process (e.g., security requirements are not as demanding and in some cases self-certification might be sufficient). The medium trust level 206 of the hierarchy 200 includes merchant-approved scripts. The merchant-approved scripts on the medium trust level 206 provide a way for a merchant to customize their customer's point of sale (POS) experience, such as by allowing customized prompts, conducting a customer survey, or by promoting sales (e.g., advertisements). Merchant-approved scripts on the medium trust level 206 can be interpretable (e.g., they do not execute directly on the hardware), have a limited set of processing and I/O capabilities and, as such, are relatively easy for a merchant to review and verify that they do not contain rogue components that attempt to skim plaintext PIN data for malicious purposes. The merchant approves the scripts on the medium trust level 206 via digital signature—outside certification is not required for this approval.

The next level down is the low trust level 208. The low trust level 208 includes merchant-approved processes (e.g., these processes could include executable and interpretable scripts). The merchant-approved processes are considered untrustworthy, and if given access to sensitive data may inadvertently allow skimming or misappropriation of the data. For example, the low trust level 208 can include but is not limited one or more general-purpose applications, such as inventory control software, an email client, and so forth. The merchant self-approves these processes by using administrator control of the platform, but this does not guarantee that these processes are free from viruses or spyware since the merchant is not always able to fully inspect the software for rogue components. The last level or no trust level 210 contains unapproved processes or scripts, such as processes external to the device or user-(non-administrator) installed software. For example, an employee may download an unapproved game onto the mobile device. Merchants typically use administrative controls to exclude the unapproved processes or scripts from being loaded onto their mobile devices. It is to be appreciated that the foregoing is but one example, and a plurality of domains of trust and classifications are possible within the scope and spirit of the subject innovation.

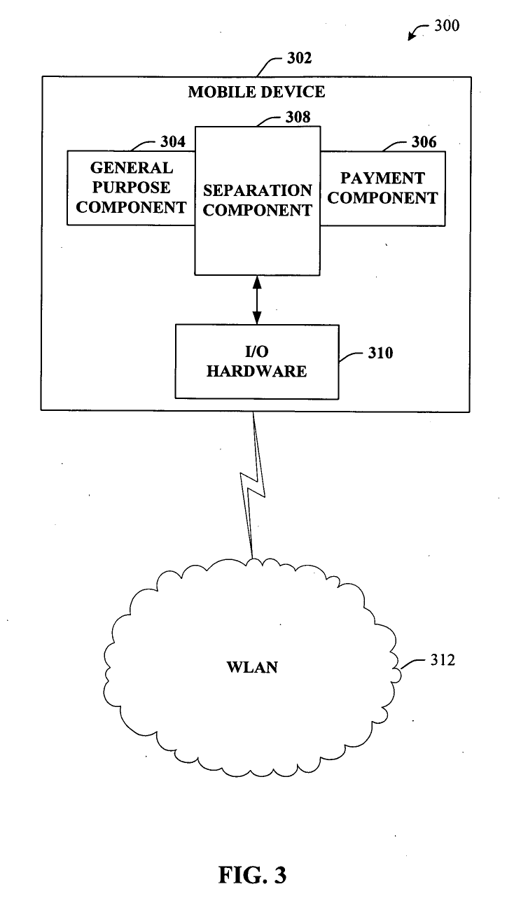

FIG. 3 illustrates a dual-purpose mobile computing and payment device in accordance with an aspect of the subject innovation. As discussed previously, the mobile device 302 can include devices such as cell phones, smart phones, laptops, handheld communication devices, handheld computing devices, satellite radios, global positioning systems, PDAs, and so forth. The mobile device 302 includes a general-purpose component 304, a payment component 306, a separation component 308, and a set of input/output (I/O) hardware 310.

The general-purpose component 304 enables the mobile device 302 to execute merchant-approved processes, including but not limited to e-mail clients, employee applications, business/product applications, and so forth. In other words, most any low-trust and no-trust applications (e.g., general-purpose applications) are executed by the general-purpose component 304 (See FIG. 2). The general-purpose component 304 can have flexible software management. For example, a manager or employee may have permission or the ability to download or install applications to the general-purpose component 304 of the mobile device 302. Consequently, the general-purpose component 302 can become infected by malicious applications that can harm or obtain information from the mobile device 302.

The payment component 306 enables the mobile device 302 to process credit or debit card payments. The payment component 306 can obtain payment data (such as a PIN, track data, a signature, and account information) from a credit/debit card via a plurality of ways, including but not limited to reading a magnetic stripe, monitoring near field communications (NFC), communicating with a contacted or contactless smart card (e.g., a chip and PIN card), and so forth. Highest-trust, high-trust, and medium-trust applications can be executed by the payment component 306 (See FIG. 2). It can be easily appreciated that it is necessary to segregate the payment component 306 from the general-purpose component 304 in order to protect the payment data.

The separation component 308 isolates, segregates, or otherwise separates the processes and scripts executed by the general component 304 from those executed by the payment component 306. For example, if an employee is using the mobile device 302 to perform a price check for a customer, the price check is executed by the general-purpose component 304. If the customer would like to purchase the product via a credit/debit card transaction using the mobile device, then the payment component 306 would execute the processes necessary to complete the card transaction. The separation solution 308 ensures that general-purpose component 304 does not have access to the data maintained or acquired by the payment component 306 and vice versa. For instance, if the general-purpose component 304 contains a malicious untrusted application, the separation component 306 denies the untrusted application access to processes and/or scripts executed by the payment component 306. The separation component 308 can separate the general-purpose component 304 and the payment component 306 via a plurality of techniques, including but not limited to virtualization technology, hardware separation, and so forth.

As previously discussed, the mobile device 302 is in communication with a wireless local area network (WLAN) 312. The WLAN 312 can be accessed via an access point and a server (not shown) that is in communication with a global communication framework, such as the Internet. The general-purpose component 304 can communicate with other mobile devices, download applications, obtain data, and so forth via the WLAN 312. Additionally or alternatively, the payment component 306 can transmit the payment data to a financial service provider for processing via the WLAN 312.

The I/O hardware 310 allows for user interaction with the device, and allows the mobile device 302 to communicate with one or more networks, other mobile devices, and so forth. For example, the I/O hardware 310 can include but is not limited to a keypad, a display screen, a touch screen/pad, a set of communication ports (e.g., parallel, serial, USB, etc.), and so forth. The I/O hardware 310 can be shared by the general-purpose component 304 and the payment component 306, and can facilitate integration with a wide array of applications. For example, an employee may use a keypad on the mobile device 302 to send an e-mail, and also to allow a customer to use the keypad to enter a PIN number when conducting a credit/debit card transaction. Furthermore, the I/O hardware can include a printer or a communication port connected to a printer that allows the mobile device 302 to produce a receipt for a credit/debit card transaction.

The separation component 308 can ensure that only one of the general-purpose component 304 or payment component 306 have access to the I/O hardware at a given time. For example, if the payment component 306 is executing a card transaction that requires the customer to enter their PIN number, then the separation component 308 segregates the general-purpose component from the I/O hardware (e.g., keypad, touch pad, touch screen, etc.) to ensure that the payment data is secure.

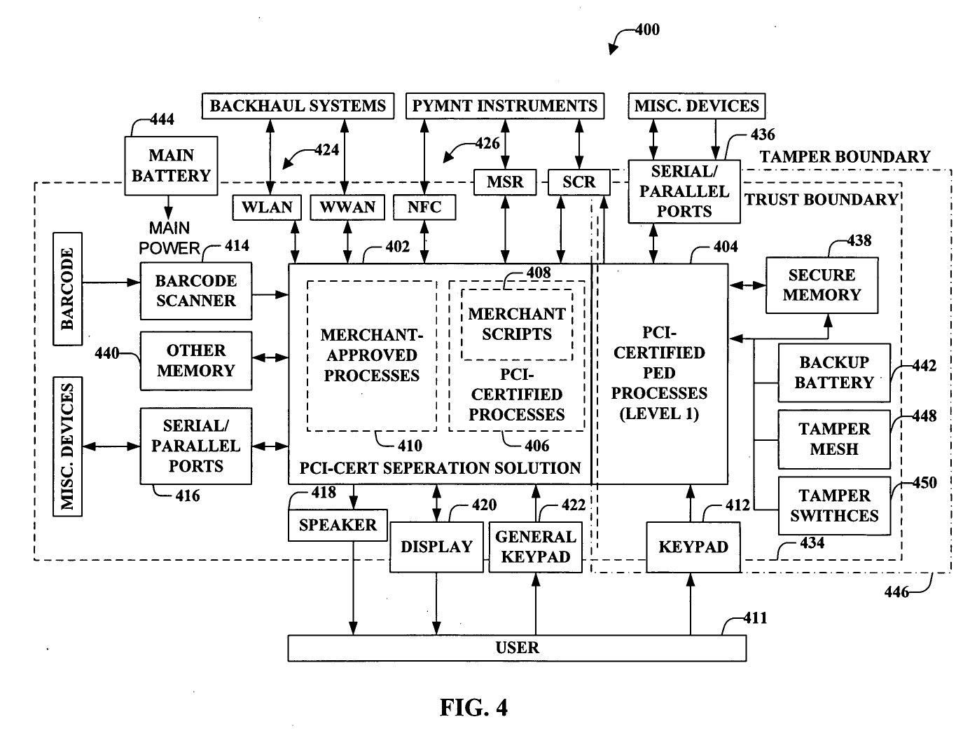

FIG. 4 illustrates an example block diagram schematic of a mobile device including a secure payment solution in accordance with one or more aspects of the subject innovation. The device 400 includes a payment card industry (PCI) certified separation solution 402 that isolates, segregates or otherwise separates scripts and/or processes of different trust levels (See FIG. 2). In particular, the PCI-certified separation solution 402 can isolate one or more payment card industry certified pin entry device processes (e.g. PIN-certified PED processes, level 1, or highest trust) 404 from one or more PCI certified processes 406 including one or more merchant scripts 408, and/or one or more merchant-approved processes 410.

As discussed supra, the PCI-certified PED processes 404 include processes that are trusted to handle plaintext PIN data. For example, if a customer makes a purchase using a credit/debit card that requires a user 411 to enter their PIN number, they would do so via a PCI-certified PED process 404. The user 411 can input data for one or more PCI-certified PED process 404 using a keypad 412. The PCI-certified separation solution 402 ensures that the keypad 412 is segregated from a keypad 422, and unavailable to the set of merchant-approved process 410 or PCI-certified processes 406. Typically PCI-certified PED processes 404 must comply with a set of PED security requirements, and are subject to certification by a PCI-approved lab.

Generally, the PCI-certified processes 406 are trusted to handle sensitive customer information that does not include plaintext PIN data. For instance, the device 400 can have an operating system (e.g., WinCE, etc.) including a payment application that can handle collection of payment data via magnetic strip, NFC, and so forth. However, the payment application is not trusted to collect plaintext PINs. In addition, the PCI-certified processes 406 can include a set of merchant scripts 408. For instance, the merchant scripts 408 can be a set of customized prompts to promote a sale or conduct a survey at the point of sale (POS). The merchant scripts 408 are trusted to not ask for plaintext PIN data. Furthermore, the merchant-approved processes 410 are typically considered untrustworthy, relative to the PCI-Certified Processes 406 and the PCI-Certified PED Processes 404, and may inadvertently allow misappropriation of sensitive data if given access.

The merchant-approved processes 410 and PCI-certified processes 406 (e.g. Non-PED processes) can communicate with the user 411, other mobile devices, networks, or computers via a plurality of inputs/outputs (I/O). The I/O can include but is not limited to a barcode scanner 414, a set of communication ports 416 (e.g., parallel/serial/usb, etc.), a speaker 418, a display 420, a keypad 422, and a set of wireless network devices 424 (e.g., WLAN, WWAN). In addition, the Non-PED processes 406 can receive payment data from payment instruments (e.g. credit/debit cards) via most any commonly used technique, including NFC 426, MSR 428, and/or SCR 430. The aforementioned I/O can also be segregated from the PCI-certified PED processes 404 by the PCI-certified separation solution 402. For instance, merchant-approved processes 410 may not have access to the network devices 424 when PCI-certified PED processes 404 are using these devices, because the merchant-approved processes may inadvertently skim critical information if given access. The PCI-certified separation solution 402 can separate most any of the I/O in a trust boundary 434 from the PCI-certified PED processes 404 (discussed infra) in order to maintain the integrity of the payment data.

The PCI-certified PED processes 404 have exclusive access to a separate set of I/O, including but not limited to a set of communication ports 436, and a keypad 412. In addition, the PCI-certified PED processes 404 have a secure memory 438 that is separate from the device memory 440. Furthermore, the PCI-certified PED processes 404 and associated components are maintained within a tamper boundary 446. The tamper boundary 446 encloses a backup battery 442 that can provide power to the secure memory 438 and in the event of a main battery failure. A tamper mesh 448, and one or more tamper switches 450 within the tamper boundary 446 will detect any physical tampering. If the tamper mesh 446 or tamper switches 448 detect that the PCI-certified PED processes 404 or related components are being tampered with they can trigger the secure memory to erase its contents. For instance, if the device 400 is physically disassembled, activation of one or more of the tamper switches 448 or disruption in the tamper mesh 446 will signal the secure memory 438 to erase its contents. The contents of the secure memory 438 can include payment data, such as PIN numbers, account numbers, PIN encrypting keys, and so forth. It is to be appreciated that this is but one example, and a plurality of mobile devices and techniques are possible within the scope and spirit of the subject innovation.

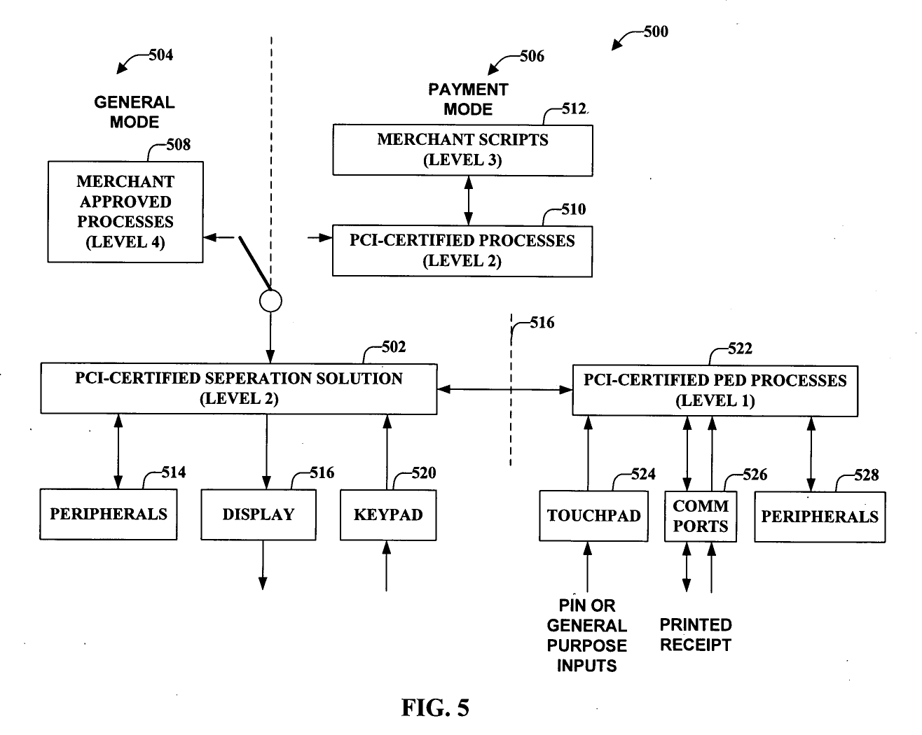

Turning to FIG. 5, an example block diagram of a mobile computing device with an integrated secure payment solution is shown in accordance with an aspect of the subject innovation. The device 500 includes a PCI-certified separation solution 502 (e.g., hypervisor) that can switch the device 500 between a general mode 504 and a payment mode 506. The general mode contains a set of merchant-approved processes 508. As discussed previously, the merchant-approved processes 508 may contain security holes (e.g., virus). For example, the merchant-approved processes 508 may include an email client, wherein a user could download or receive a virus. Consequently, the PCI-certified separation solution 502 segregates the general mode 504 merchant-approved processes 508 from the payment mode 506.

The PCI-certified separation solution 502 can be hardware, software (e.g., virtualization), or a combination of the two, and can switch the device 500 from general mode 504 to payment mode 506 automatically or based on a user command. Switches made between general mode 504 and payment mode 506 are audited, and can require management approval. For example, the mobile device 500 can record or advise a supervisor that a switch has occurred. In addition, mode switches are explicitly indicated. For instance, a retail store employee can have the device 500 in general mode while performing an inventory update. If a customer would like for the employee to process a credit card transaction via the device 500, then a manager's approval may be required to switch the device from general mode 504 to payment mode 506. In addition, an indicator can be used to display the current mode of the device 500, such as an LED indicator, one or more graphical indicators on a display 516, an audible indicator, and so forth. This can be done in order to make it more difficult for a rogue application (e.g., installed by an unscrupulous employee) to simulate a switch to payment mode, while actually remaining in the general mode. For example, The rogue application may display a request for restricted data (e.g., a customer's PIN) in an effort to illicitly capture this information. The payment mode indicator under these conditions will not be activated, alerting the customer to caution. If the inactive payment mode indicator escapes the attention of the customer and restricted data, such as a PIN is obtained, the rogue application will be unable to complete a valid payment transaction and a receipt will not be printed. As an additional example, a rogue employee or application could try to fool the consumer into thinking that the first PIN submission had a glitch. The first PIN entry would be done in general mode with the rogue application skimming the PIN. After this transaction “glitches”, the consumer could willingly submit a PIN for a second time (i.e., this time in payment mode) to actually complete the transaction. When the rogue application attempts to switch to payment mode to complete the payment transaction, the audit record will record this switch and, furthermore, authorization from a manager may be needed for this switch. While a rogue employee or application may be able to succeed in illicitly capturing PIN data in general mode and then switching to payment mode a small number of times, attempting such an attack on large number of transactions will raise suspicion and always leave evidence pointing to the attack.

In addition, the PCI-certified separation solution 502 could audit whenever data is scanned or captured by the NFC 426, MSR 428, or SCR 430 devices while operating in general mode. Since the PCI-certified separation solution 502 would handle this auditing, a rogue process, executing in general mode, could not subvert it. With these solutions, if the employee regularly attempts to illicitly acquire payment data by repeatedly switching modes or by using the payment scanning hardware in general mode, the audit record will exist and this evidence can processed either manually or automatically to uncover such suspicious actions. Hence, the risk of detection for a rogue employee or attacker trying to subvert the mobile payment/computing device is raised, leading to a lower probability that such attempts will be made.

As discussed supra, the payment mode 506 can include a set of PCI-certified processes 510 and a set of merchant scripts 512. For instance, in payment mode 506 the device can include one or more PCI-certified processes, such as an operating system having a payment application that can obtain credit/debit card information via MSR, NFC, and/or SCR. In addition, the payment mode 506 can include a set of merchant scripts 512, such as a POS survey. The payment application and survey are trusted not to ask for plaintext PIN data and are trusted to not include rogue software (e.g., a virus). Furthermore, the merchant-approved processes 508, PCI-certified processes 510, and merchant scripts 512 can share the same I/O hardware, including, for example, a first set of peripherals 514, a display 516, and a keypad 520. However, the separation solution 502 can isolate the general mode processes 504 from the I/O hardware when the device 500 is in payment mode 506.

The separation solution 502 isolates a set of PCI-certified PED processes 522 from the processes executing in general mode 504. In addition, the separation solution 502 can effectuate one or more trust boundaries 516 between the PCI-certified processes 510/merchant scripts 512 and the PCI-certified PED processes 522. The PCI-certified PED processes 522 have the highest trust level, and are trusted to handle plaintext PIN data. As a consequence, the PCI-certified PED processes 522 have direct control over a separate set of I/O hardware that can be shared with the other processes (e.g., 508, 510, and 512), including but not limited to a keypad 524, a set of communication ports 526, and a second set of peripherals 528.

In one possible embodiment, keypad 524 and display 516 are subcomponents of a touchscreen device. That is, the keypad 524 is a touchable component of the display 516 and functions to capture a user's key presses on the screen. For instance, the keypad 514 can sit below the display 516. Both of these subcomponents can be shared between general mode 504 and payment mode 506 processes and access is controlled by the PCI-certified separation solution 502. The PCI-certified separation solution 502 allows the PCI-certified PED processes 522 to know, with a high-level of trust, whether the device is in general mode 504 or payment mode 506. When in general mode 504, the keypad 524 is accessible to merchant-approved processes 508. The PCI-certified PED processes 522, which control this access, ensure that the PIN-encrypting keys are not available for use by the merchant-approved processes 508 (since in general mode no payment transactions should ever take place). When in payment mode, the keypad 524 is accessible to PCI-certified processes 510 and merchant scripts 512. In this case, the PCI-certified PED processes 522, which control this access, allow access to the PIN-encrypting keys (so that the PIN entered during a payment transaction can be properly encrypted for handling by the backend system).

As a further example, in operation the device 500 can be switched to payment mode 506 with a manager's approval. For example, an employee with sufficient security clearance may be required to enter a password, fingerprint, retinal scan, and so forth to authorize a switch from a first mode to a second mode. A payment application collects data from a customer's debit card via MSR, and a short survey (e.g., was the store clean?) is answered by the customer via the keypad 520 or keypad 524. Subsequently, the customer can be required to enter their PIN number via the keypad 524. A receipt can be printed via the communication ports 526 if the transaction is successful. The printed receipt can serve as an additional audit mechanism. If the device was not actually in payment mode 506, then a receipt cannot be printed. Such control of receipt printing can be achieved, for example, if the communication port is only available to processes executing in payment mode 506, or the printer will only print receipts that can be verified as originating from a trusted process running in payment mode 506, where such verification can be handled using cryptographic means. Controlled printing of receipts prevents a malicious untrusted process (e.g., a rogue merchant-approved process 508) from behaving like a trusted PCI PED certified process (e.g., 510, 512 or 522) and printing fake receipts to trick the customer into believing that a transaction succeeded, when in fact the PIN was simply skimmed and never submitted to the backend for approval.

The separation solution 502 can enable a user or administrator to update the device's 500 merchant-approved processes 508 or merchant scripts 512 without having to recertify the device 500. In addition, the separation solution 502 can enable a device to share at least some common I/O hardware, and maintain the level of security required for PCI and PED processes. It is to be appreciated that this is but one example, and a plurality of techniques are possible for separating the general mode 504 and payment mode 506 within the scope and spirit of the subject innovation.

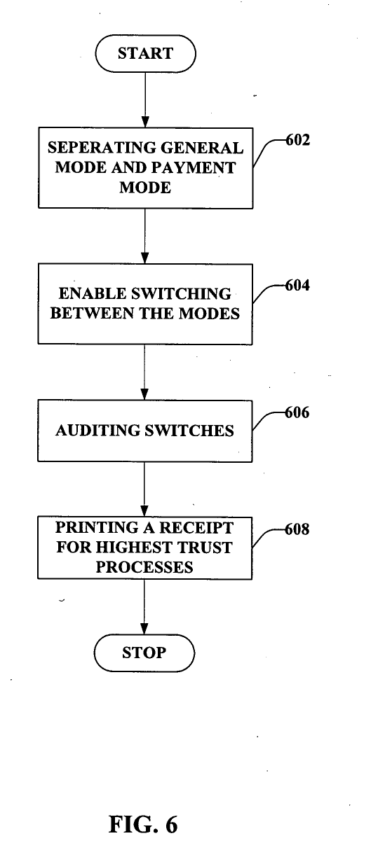

In view of the exemplary systems and techniques described supra, a methodology that may be implemented in accordance with the disclosed subject matter will be better appreciated with reference to the flow chart of FIG. 6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, the illustrated blocks do not represent all possible steps, and not all illustrated blocks may be required to implement the methodologies described hereinafter.

Referring now to FIG. 6, an example methodology for enabling a secure environment for trusted and untrusted processes to share the same hardware is shown in accordance with an aspect of the subject innovation. At 602, a general mode and a payment mode are separated by a payment card industry (PCI) certified separation solution. The general mode can include merchant-approved processes, such as an email client, employee management applications, inventory applications, and so forth. The payment mode can include PCI-certified processes, merchant scripts, and PCI-certified PIN entry device processes.

At 604, switching between the general mode and payment mode is enabled. Switching modes is handled by the separation solution that prevents less trusted processes and/or scripts from accessing data obtained or acquired by more trusted processes and/or scripts. At 606, switching between the modes is audited. For example, a device can maintain a record of every switch that occurs or record switches into payment mode. Additionally or alternatively, each switch between modes can be reported to a central monitoring site or supervisor, and/or can require a supervisor's authority to complete the switch. The central monitoring site can observe switching activities and automatically generate alarms when unusual or suspicious switching activities are observed. Likewise, a person can view the audit logs and look for such suspicious activities, for either preventative or forensic purposes.

At 608, a receipt is printed only if authorized by a trusted process, such as a process executing in payment mode 506 on the mobile device 500 (e.g., a PCI-certified PED processes or PCI-certified processes) or a process executing in a backend server that is trusted to handle payment transactions. For example, if a card transaction is processed that requires entry of a PIN, then a payment-mode process will authorize the printing of a receipt to confirm the transaction. This can prevent schemes in which an employee or rogue software or hardware attempts to acquire protected information in general mode, because a receipt can only be printed by trusted processes that are in payment mode.

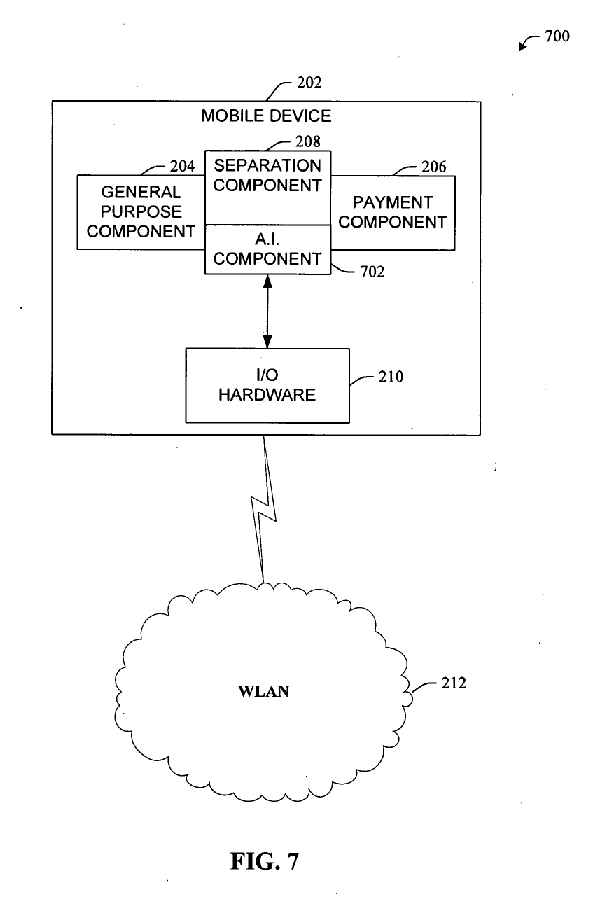

FIG. 7 illustrates a system 700 that employs an artificial intelligence (AI) component 702 that facilitates automating one or more features in accordance with the subject invention. The subject invention (e.g., in connection with inferring) can employ various AI-based schemes for carrying out various aspects thereof. For example, a process for automatically switching between a trusted mode (e.g., payment mode) and untrusted mode (general mode) can be facilitated via an automatic classifier system and process.

A classifier is a function that maps an input attribute vector, x=(x1, x2, x3, x7, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to update or refine the previously inferred schema, tighten the criteria on the inferring algorithm based upon the kind of data being processed (e.g., financial versus non-financial, personal versus non-personal, . . . ), and at what time of day to implement tighter criteria controls (e.g., in the evening when system performance would be less impacted).

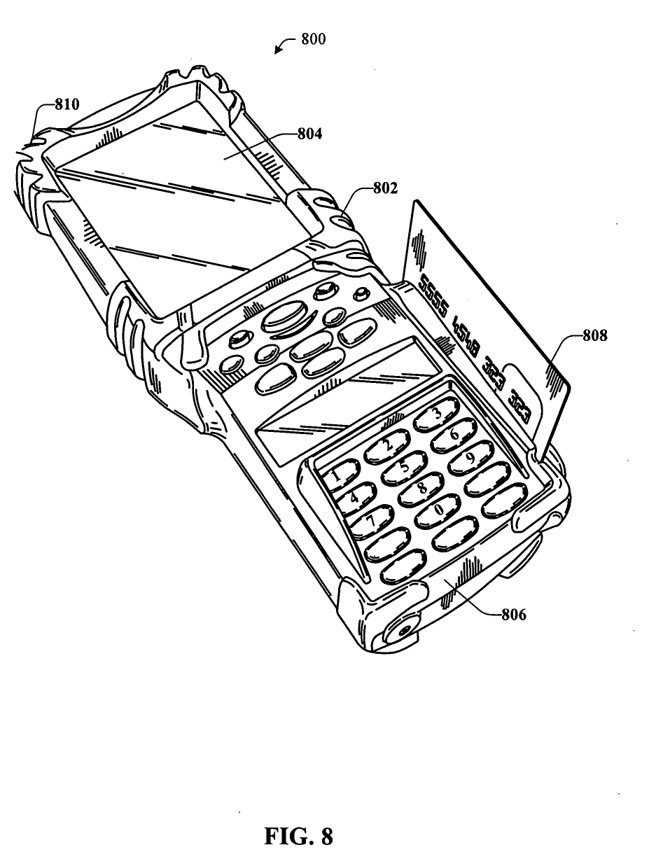

FIG. 8 is provided to assist in understanding and to provide context to an embodiment of the invention. Specifically, FIG. 8 illustrates an example of a handheld terminal 800 operative to execute the systems and/or methods disclosed herein. It is to be understood that the handheld terminal shown and described is merely exemplary and other devices can be utilized in accordance with the subject disclosure.

The handheld terminal 800 can include a housing 802, which can be constructed from a high strength plastic, metal, or any other suitable material. The handheld terminal 800 can also include a display 804. As is conventional, the display 804 functions to display data or other information relating to ordinary operation of the handheld terminal 800 and/or mobile companion (not shown). For example, software operating on the handheld terminal 800 and/or mobile companion can provide for the display of various information requested by the user.

Additionally, the display 804 can display a variety of functions that are executable by the handheld terminal 800 and/or one or more mobile companions. The display 804 can provide for graphics based alphanumerical information such as, for example, the price of an item requested by the user. The display 804 can also provide for the display of graphics such as icons representative of particular menu items, for example. The display 804 can also be a touch screen, which can employ capacitive, resistive touch, infrared, surface acoustic wave, or grounded acoustic wave technology.

The handheld terminal 800 can further include user input keys 806 for allowing a user to input information and/or operational commands. The user input keys 806 can include a full alphanumeric keypad, function keys, enter keys, etc. The handheld terminal 800 can also include a magnetic strip reader 808 or other data capture mechanism (not shown). An electronic signature apparatus can also be employed in connection with the magnetic strip reader or a telecheck system.

The handheld terminal 800 can also include a window 810 in which a bar code reader/bar coding imager is able to read a bar code label, or the like, presented to the handheld terminal 800. The handheld terminal 800 can include a light emitting diode (LED) (not shown) that is illuminated to reflect whether the bar code has been properly or improperly read. In addition, the LED or another visual indicator (e.g., some additional area on the display, a lit frame around the display, a padlock icon, etc.) can explicitly indicate the mode of the terminal 800. For example, if the indicator is driven by a trusted process, then it could be used by a customer to know when it is “safe” to enter a PIN.

Alternatively or additionally, a sound can be emitted from a speaker (not shown) to alert the user that the bar code has been successfully imaged and decoded. The handheld terminal 800 can also include an antenna (not shown) for wireless communication with a radio frequency (RF) access point; and an infrared (IR) transceiver (not shown) for communication with an IR access point.

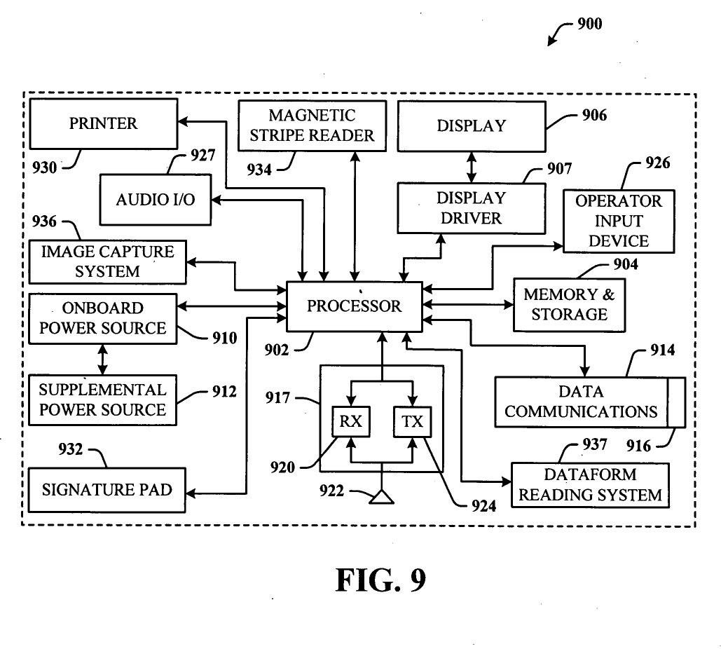

Referring now to FIG. 9, illustrated is a schematic block diagram of a portable hand-held terminal device 900 according to one aspect of the invention, in which a processor 902 is responsible for controlling the general operation of the device 900. The processor 902 is programmed to control and operate the various components within the device 900 in order to carry out the various functions described herein. The processor 902 can be one or more of any of a plurality of suitable processors. For example, an application processor can handle everything except the PCI-certified PED processes. These processes could instead be hosted on a separate processor that has a battery-backed random access memory (RAM) which maintains one or more PIN encrypting keys. The keys can be maintained in the RAM so that they can be quickly erased in the event of tamper detection (as previously discussed). A back-up battery could be used to allow a main battery to be replaced without clearing out the keys. The manner in which the processor 902 can be programmed to carry out the functions relating to the invention will be readily apparent to those having ordinary skill in the art based on the description provided herein.

A memory 904 connected to the processor 902 serves to store program code executed by the processor 902, and serves as a storage means for storing information such as user credential and receipt transaction information and the like. The memory 904 can be a nonvolatile memory suitably adapted to store at least a complete set of the information that is displayed. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information, and the processor 902 could include a program for alternating or cycling between various sets of display information.

A display 906 is coupled to the processor 902 via a display driver system 907. The display 906 can be a color liquid crystal display (LCD), plasma display, or the like. In this example, the display 906 is a ¼ VGA display with sixteen levels of gray scale. The display 906 functions to present data, graphics, or other information content. For example, the display 906 can display a set of customer information, which is displayed to the operator and can be transmitted over a system backbone (not shown). Additionally, the display 906 can display a variety of functions that control the execution of the device 900. The display 906 is capable of displaying both alphanumeric and graphical characters.

Power is provided to the processor 902 and other components forming the hand-held device 900 by an onboard power system 910 (e.g., a battery pack). In the event that the power system 910 fails or becomes disconnected from the device 900, a supplemental power source 912 can be employed to provide power to the processor 902 and to charge the onboard power system 910. The processor 902 of the device 900 induces a sleep mode to reduce the current draw upon detection of an anticipated power failure.

The terminal 900 includes a communication subsystem 914 that includes a data communication port 916, which is employed to interface the processor 902 with a remote computer. The port 916 can include at least one of Universal Serial Bus (USB) and IEEE 1394 serial communications capabilities. Other technologies can also be included, for example, infrared communication utilizing an infrared data port.

The device 900 can also include a radio frequency (RF) transceiver section 917 in operative communication with the processor 902. The RF section 917 includes an RF receiver 920, which receives RF signals from a remote device via an antenna 922 and demodulates the signal to obtain digital information modulated therein. The RF section 917 also includes an RF transmitter 924 for transmitting information to a remote device, for example, in response to manual user input via a user input device 926 (e.g., a keypad) or automatically in response to the completion of a transaction or other predetermined and programmed criteria. The transceiver section 917 facilitates communication with a transponder system, for example, either passive or active, that is in use with product or item RF tags. The processor 902 signals (or pulses) the remote transponder system via the transceiver 917, and detects the return signal in order to read the contents of the tag memory. In one implementation, the RF section 917 further facilitates communications using the device 900. In furtherance thereof, an audio I/O section 927 is provided as controlled by the processor 902 to process voice input from a microphone (or similar audio input device) and audio output signals (from a speaker or similar audio output device).

In another implementation, the device 900 can provide voice recognition capabilities such that when the device 900 is used simply as a voice recorder, the processor 902 can facilitate high-speed conversion of the voice signals into text content for local editing and review, and/or later download to a remote system, such as a computer word processor. Similarly, the converted voice signals can be used to control the device 900 instead of using manual entry via the keypad 926. Also, speaker identification technology can be used to identify the speaker based on their voice and use this identification to authorize a switch from general mode to payment mode (or payment mode to general mode). It is to be appreciated that this is but one example, and a plurality of security measures, such as other biometrics, can be used to enable a switch, including but not limited to fingerprint detection, facial recognition, iris recognition, and so forth.

Onboard peripheral devices, such as a printer 930, signature pad 932, and a magnetic strip reader 934 can also be provided within the housing of the device 900 or accommodated externally through one or more of the external port interfaces 916.

The device 900 can also include an image capture system 936 such that the user can record images and/or short movies for storage by the device 900 and presentation by the display 906. Additionally, a dataform reading system 937 is included for scanning dataforms. It is to be appreciated that these imaging systems (936 and 937) can be a single system capable of performing both functions.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system facilitating secure processes, comprising:
a general-purpose component that executes unsecure processes;
a payment component that executes secure processes; and
a separation component that separates the general-purpose component and the payment component, and enables switching between the general-purpose component and the payment component.

2. The system of claim 1, the unsecure processes include at least one of a set merchant-approved processes, or at least one general-purpose application.

3. The system of claim 1, the secure processes include at least one of: a set of merchant scripts, a set of payment card industry certified processes, or a set of payment card industry certified PIN entry device processes.

4. The system of claim 1, further comprising a set of input/output hardware.

5. The system of claim 4, the separation component controls access by the general-purpose component and payment component to the input/output hardware.

6. The system of claim 1, the separation component audits switches to at least one of the general-purpose component, or the payment component.

7. The system of claim 6, wherein the audit includes at least one of: maintaining a record of each switch, reporting switches between the general-purpose component and payment component, or requiring an authorization for the switch between the general-purpose component and payment component.

8. The system of claim 1, the payment component produces a receipt for payment card industry certified pin entry device processes.

9. A method for facilitating a secure environment for trusted processes on a device, comprising:
separating a general mode and a payment mode, and executing untrusted processes in the general mode and trusted processes in the payment mode;
enabling secure switching between the general mode and payment mode, wherein the switching separates the trusted and untrusted processes; and
auditing the switches to at least one of the general mode, or the payment mode.

10. The method of claim 9, the untrusted processes include at least one of a set merchant-approved processes, or at least one general-purpose application.

11. The method of claim 9, the secure processes include at least one of: a set of merchant scripts, a set of payment card industry certified processes, or a set of payment card industry certified PIN entry device processes.

12. The method of claim 9, further comprising enabling the general mode and payment mode to share a set of input/output hardware.

13. The method of claim 12, further comprising segregating the input/output hardware from at least one of the payment or general mode based on which mode is the active mode.

14. The method of claim 9, the step of auditing the switches further comprises at least one of: maintaining a record of each switch between the general mode and payment mode, reporting switches between the general mode and payment mode, or requiring a supervisor's authority for the switch between the general mode and payment mode.

15. The method of claim 9, further comprising printing a receipt when a valid payment transaction is completed, wherein a valid payment transaction is one that has been either approved or disapproved by a backend payment system.

16. A system for trusted processing, comprising:
means for separating an untrusted mode and a trusted mode, and executing untrusted processes in the untrusted mode and trusted processes in the trusted mode;
means for enabling secure switching between the untrusted mode and trusted mode, wherein the switching separates the trusted and untrusted processes;
auditing the switches between the modes via at least one of: maintaining a record of each switch, reporting switches, or requiring a security clearance in order to switch; and
printing a receipt only if authorized by at least one secure process.

17. The system of claim 16, the untrusted processes include at least one of a set merchant-approved processes, or at least one general-purpose application.

18. The system of claim 16, the secure processes include at least one of: a set of merchant scripts, a set of payment card industry certified processes, or a set of payment card industry certified PIN entry device processes.

19. The system of claim 16, further comprising means for sharing at least a set of input/output hardware between the trusted and untrusted modes, and segregating the input/output hardware from at least one of the payment or general mode based on which mode is the active mode.

20. The system of claim 16, further comprising means for detecting tampering with the device and erasing a secure memory that maintains data from at least one trusted process.

21. The system of claim 16, wherein the security clearance includes biometric identification.

22. An apparatus for trusted processing, comprising:
a first component that host low-trust processes;
a second component that host high-trust processes;
a third component that host highest-trust processes; and
a fourth component that regulates allocation of a set of input/output hardware between the first component, second component, and third component.

23. The apparatus of claim 22, wherein at least one of the first component, second component, or third component is at least one of a virtual machine or a processor.

24. The apparatus of claim 22, the low trust processes include at least one merchant-approved process.

25. The apparatus of claim 22, the high trust processes include at least one payment card industry certified process.

26. The apparatus of claim 22, the highest trust processes include at least one payment card industry certified pin entry device process.

27. The apparatus of claim 26, wherein the payment card industry certified pin entry device processes control switching between a set of modes, the set of modes include at least one payment mode, and at least one general mode.

28. The apparatus of claim 22, wherein the fourth component is a hypervisor.
